(19) United States
(12) Patent Application Publication
(10) Pub. No.: US 2026/0246216 A1
(43) Pub. Date: Aug. 20, 2026

(54) TERMINAL BLOCK

(71) Applicant: Yazaki Corporation, Tokyo (JP)

(72) Inventors: Sota ARAI, Makinohara-shi (JP); Masato AKINO, Makinohara-shi (JP); Yasuhiro TANAKA, Makinohara-shi (JP); Yasuhiro OTSUTA, Makinohara-shi (JP); Masatoshi YAMADA, Makinohara-shi (JP); Yusuke TSUTAGAWA, Makinohara-shi (JP)

(73) Assignee: Yazaki Corporation, Tokyo (JP)

(21) Appl. No.: 19/460,811

(22) Filed: Jan. 27, 2026

(30) Foreign Application Priority Data
Feb. 14, 2025 (JP) 2025-022065

(51) Int. Cl. H01R 43/00; H01R 9/18; H01R 9/22

(52) U.S. Cl. CPC H01R 43/005; H01R 9/18; H01R 9/22

(57) ABSTRACT

A terminal block includes a housing that holds terminals, a gasket that is assembled to the housing to perform water blocking between the housing and the object to be fixed, and a fastening member that fastens the housing to the object to be fixed. The gasket is housed in a housing groove formed in the housing, presses a pressing part projecting from the housing groove against the object to be fixed to perform water blocking, and is formed to have a thickness in a pressing direction that becomes thinner as being closer to the fastening member.

### CROSS-REFERENCE TO RELATED APPLICATIONS

The present application claims priority to and incorporates by reference the entire contents of Japanese Patent Application No. 2025-022065 filed in Japan on February 14, 2025.

### BACKGROUND OF THE INVENTION

### 1. Field of the Invention

The present invention relates to a terminal block.

### 2. Description of the Related Art

In the related art, as a terminal block, for example, as described in JP 2023-171078 A, there is known a terminal block including a housing that holds terminals and a gasket assembled to the housing. This terminal block is assembled to an object to be fixed by fastening the housing to the object to be fixed with a fastening member while pressing the gasket against the object to be fixed to perform water blocking.

In such a terminal block, there is room for improvement in that water blocking cannot be appropriately performed by the gasket in some cases. For example, when the housing is fastened to the object to be fixed, a pressing force of the gasket tends to become small at a position distant from a fastening point. That is, as compared with a position close to the fastening point, the pressing force of the gasket becomes small at a position distant from the fastening point, and there is a concern that a water-blocking function is deteriorated. On the other hand, when a fastening force is increased to increase the pressing force of the gasket at a position distant from the fastening point, a pressing reaction force on the housing in the vicinity of the fastening point is increased, and high strength is required for the housing.

### SUMMARY OF THE INVENTION

Therefore, the present invention aims at providing a terminal block capable of appropriately performing water blocking by a gasket.

In order to achieve the above mentioned object, a terminal block according to one aspect of the present invention includes a housing that holds terminals; a gasket that is assembled to the housing to perform water blocking between the housing and an object to be fixed; and a fastening member that fastens the housing to the object to be fixed, wherein the gasket is housed in a housing groove formed in the housing, presses a pressing part projecting from the housing groove against the object to be fixed to perform water blocking, and is formed to have a thickness in a pressing direction that becomes thinner as being closer to the fastening member.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a terminal block according to an embodiment;

FIG. 2 is an exploded perspective view of the terminal block according to the embodiment;

FIG. 3 is an exploded perspective view of the terminal block according to the embodiment;

FIG. 4 is a cross-sectional view of the terminal block along IV-IV in FIG. 1;

FIG. 5 is a cross-sectional view of the terminal block along V-V in FIG. 4;

FIG. 6 is a cross-sectional view of the terminal block along VI-VI in FIG. 4; and

FIG. 7 is an explanatory diagram of assembly of the terminal block according to the embodiment.

### DETAILED DESCRIPTION OF THE PREFERRED EMBODIMENTS

The following describes an embodiment according to the present invention in detail based on the drawings. The present invention is not limited to the embodiment. In addition, constituent elements in the embodiment described below include constituent elements that can be easily replaced by those skilled in the art, or constituent elements that are substantially the same.

### Embodiment

The present embodiment relates to a terminal block. In the following description, among a first direction, a second direction, and a third direction intersecting each other, the first direction is referred to as a "depth direction X", the second direction is referred to as a "width direction Y", and the third direction is referred to as an "assembly direction Z". Herein, the depth direction X, the width direction Y, and the assembly direction Z are orthogonal to each other. Herein, "orthogonal" encompasses "substantially orthogonal". The assembly direction Z corresponds to a direction in which a housing is assembled to an object to be fixed. Each direction used in the following description represents a direction in a state where respective parts are assembled to each other unless otherwise specified.

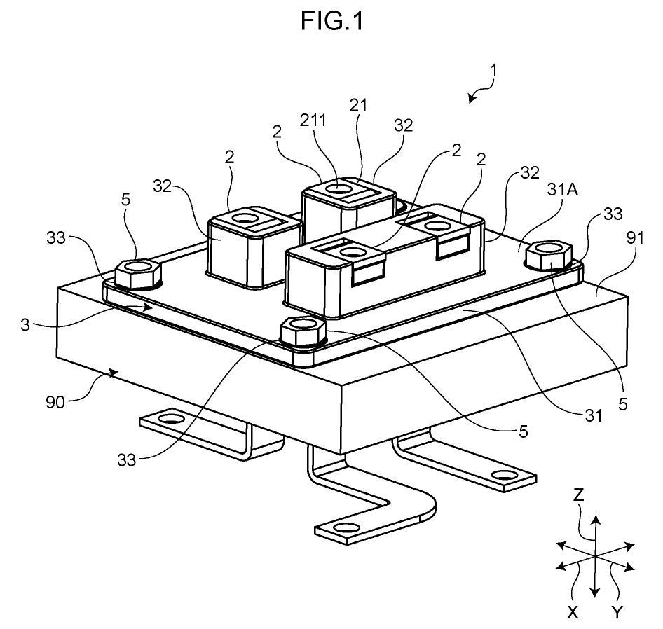

As illustrated in FIG. 1 to FIG. 3, a terminal block 1 is a component that holds terminals 2, and is used by being attached to an object to be fixed 90. The terminal block 1 is, for example, mounted on a vehicle, and holds a plurality the terminals 2 arranged along a direction intersecting the assembly direction Z. Specifically, the terminal block 1 holds two terminals 2 arranged along the depth direction X and two terminals 2 arranged along the width direction Y, that is, holds the four terminals 2 in total. The object to be fixed 90 is a vehicle unit mounted on the vehicle or disposed in the vehicle, and is, for example, a constituent part of the vehicle, a component, a member, or equipment mounted on the vehicle, and the like. The number of the terminals 2 to be installed may be a number other than four. The terminal block 1 includes a housing 3, a gasket 4, and fastening members 5.

The housing 3 is a component that holds the terminals 2 and is assembled to the object to be fixed 90, and is formed of an insulator, for example, formed of resin. The housing 3 includes a main body part 31 that holds the terminals 2. The main body part 31 has a rectangular plate shape, and is arranged to face an attachment surface 91 of the object to be fixed 90 and to be assembled to the object to be fixed 90. Herein, "rectangular" encompasses "substantially rectangular". The attachment surface 91 is a surface of the object to be fixed 90, and extends along the depth direction X and the width direction Y. The main body part 31 holds the terminals 2 penetrating therethrough along the assembly direction Z. The terminal 2 is a plate body formed in a strip shape, and is formed of an electric conductor.

A projecting part 32 is disposed on a surface part 31A of the main body part 31. The surface part 31A is a surface of the main body part 31, and is a surface on an opposite side of a back surface part 31B opposed to the object to be fixed 90. The projecting part 32 is a block-like portion projecting from the surface part 31A. The projecting part 32 is disposed at a penetrating position of the terminal 2, and supports an end part 21 of the terminal 2. For example, the end part 21 of the terminal 2 is bent from the assembly direction Z toward the width direction Y to form an insertion hole 211. The terminal 2 is configured to be fastened to the projecting part 32 by inserting a fastening member (not illustrated) into the insertion hole 211 from the assembly direction Z. A plurality of the projecting parts 32 are disposed to support one or two terminals 2. A support structure or a holding structure for the terminal 2 in the housing 3 is not limited to the structure described above.

Fastening holes 33 are formed in the main body part 31. The fastening hole 33 is a hole for inserting the fastening member 5, and is formed between the surface part 31A and the back surface part 31B of the main body part 31 to penetrate the main body part 31 along the assembly direction Z. The fastening holes 33 are respectively formed at four corner portions of the main body part 31 having a rectangular shape, for example. Fastening holes 93 are formed on the attachment surface 91 of the object to be fixed 90. The fastening holes 93 are holes for inserting the fastening members 5 that penetrate the main body part 31, and are formed at positions corresponding to the fastening holes 33.

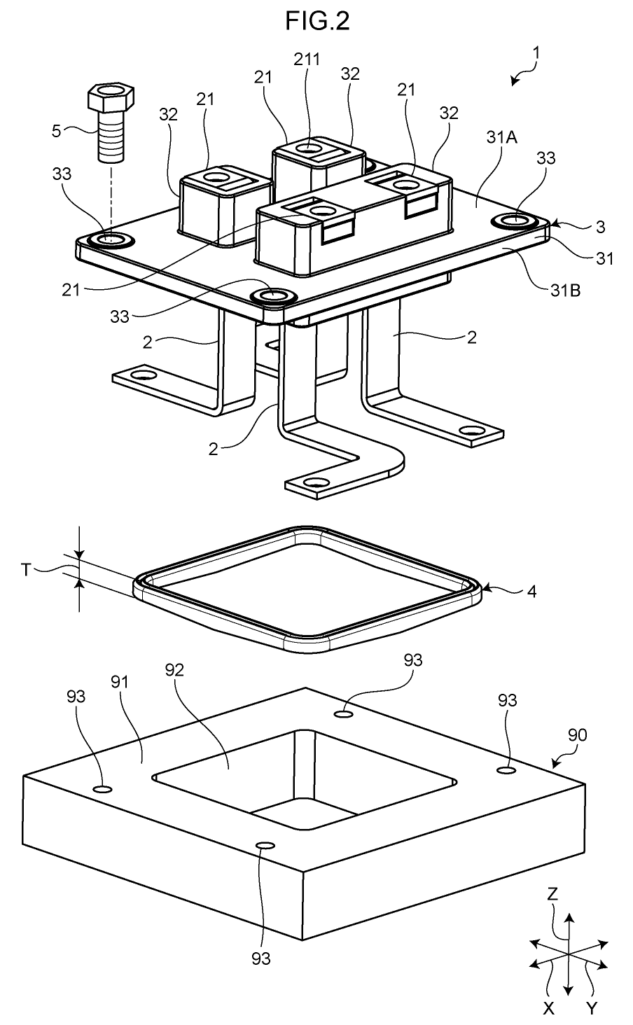

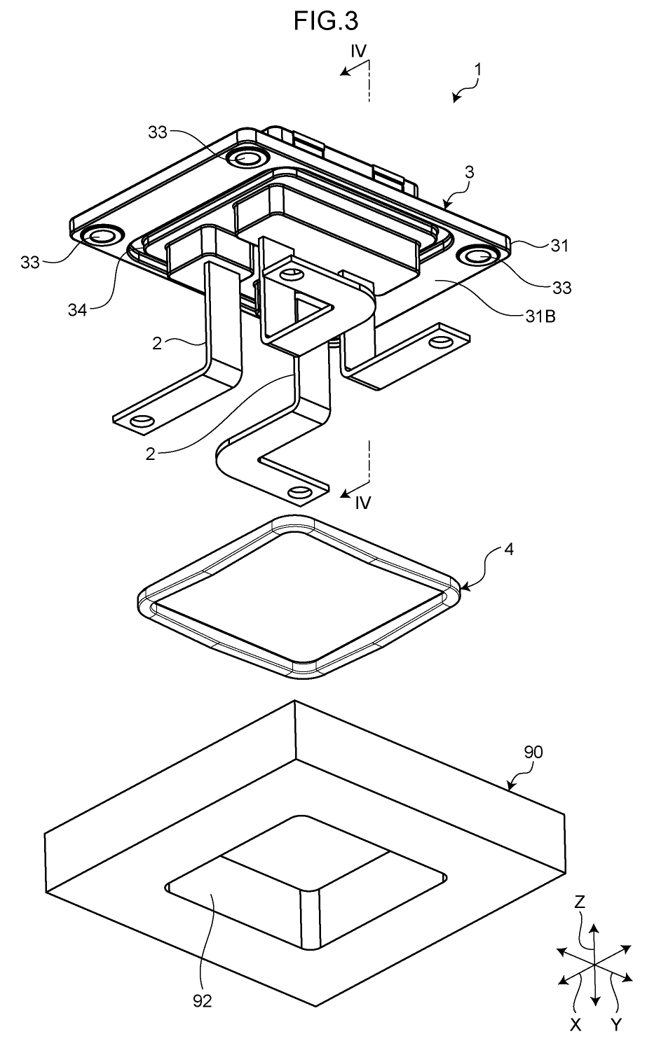

The fastening member 5 is a member that fastens the terminal block 1 to the object to be fixed 90, and, for example, a bolt is used. The fastening member 5 is disposed to penetrate the main body part 31 of the housing 3, and performs fastening to press the terminal block 1 against the object to be fixed 90. The fastening member 5 may be a stud bolt or the like that is disposed to project from the object to be fixed 90 and penetrates the main body part 31. In FIG. 2 and FIG. 3, for convenience of explanation, illustration of the fastening members 5 is appropriately omitted although the fastening members 5 are inserted into the respective fastening holes 33 to be installed.

The terminal 2 is formed to extend from the back surface part 31B and to be bent. That is, the terminal 2 is formed to be electrically connected inside the object to be fixed 90, and to be bent as needed. The terminal 2 may extend in a linear shape. In the object to be fixed 90, an opening part 92 is formed for inserting the terminal 2.

The gasket 4 is a water-blocking member that blocks water between the housing 3 and the object to be fixed 90, and is constituted of a material that can be elastically deformed. For example, the gasket 4 is formed in a ring shape, and for example, is formed in a rectangular shape in accordance with a shape of the main body part 31 of the housing 3, and is disposed to surround the opening part 92.

The gasket 4 is housed and held in a housing groove 34 formed in the housing 3. The housing groove 34 is a groove that is formed by recessing the back surface part 31B of the main body part 31 in the assembly direction Z. The housing groove 34 is formed in a shape corresponding to the gasket 4, for example, formed in a rectangular shape. In addition, the housing groove 34 is formed to surround the terminals 2 penetrating the main body part 31. The gasket 4 is formed to be thicker than a depth of the housing groove 34 and, in a state of being housed in the housing groove 34, projects a pressing part 41 from the housing groove 34. In the gasket 4, the pressing part 41 projecting from the housing groove 34 abuts against the attachment surface 91 of the object to be fixed 90 when the terminal block 1 is assembled to the object to be fixed 90, and presses the attachment surface 91 to perform water blocking.

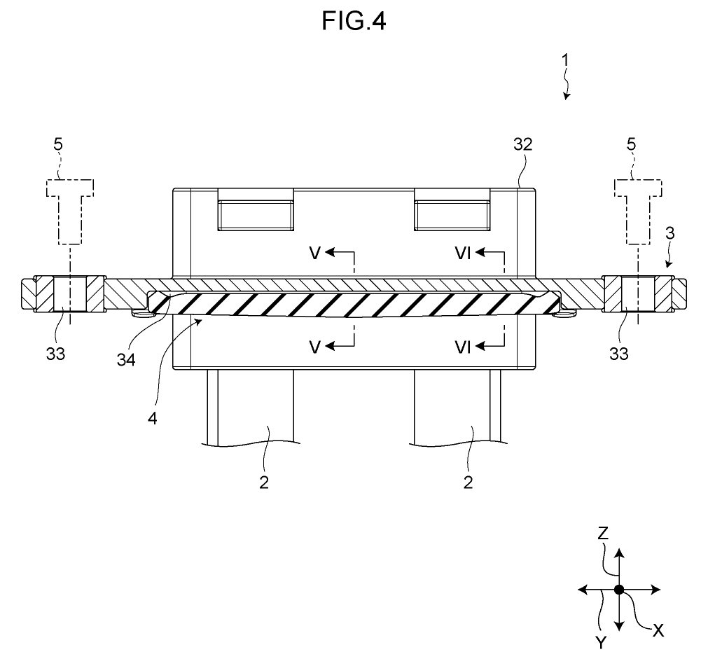

As illustrated in FIG. 4, the gasket 4 is formed so that a thickness T along a pressing direction varies in an extending direction. The pressing direction is the same direction as the assembly direction Z. The thickness T in the pressing direction of the gasket 4 is formed to be thinner as being closer to the fastening member 5. In other words, the thickness T in the pressing direction of the gasket 4 is formed to be thicker as being farther from the fastening member 5. For example, the thickness T of the gasket 4 gradually increases from an end part close to the fastening member 5 toward a center part, and is thickest at the center part.

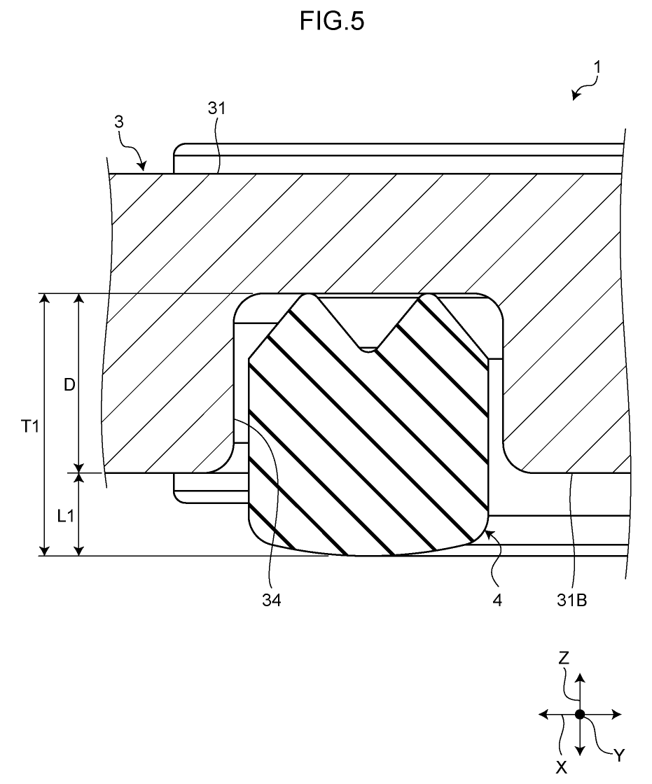

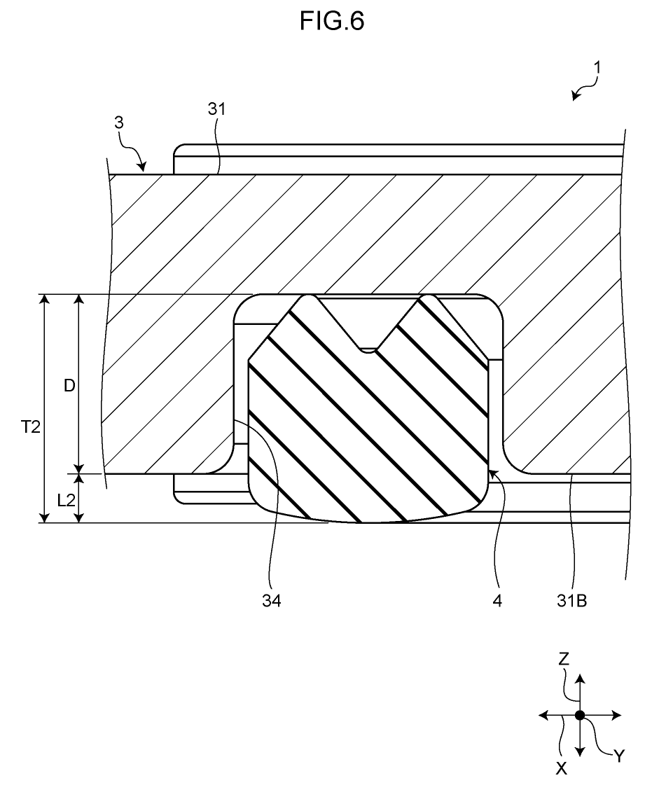

In the terminal block 1 according to the present embodiment, corner parts of the gasket 4 having a rectangular shape are arranged at positions in the vicinity of the fastening members 5, respectively (refer to FIG. 2 and FIG. 3). Due to this, the thickness T increases from the end part toward the center part at a side part between the corner parts of the gasket 4. That is, as illustrated in FIG. 5 and FIG. 6, assuming that the thickness T at the center part of the gasket 4 is a thickness T1 and the thickness T at the end part of the gasket 4 is T2, the thickness T is set to satisfy T1 > T2. FIG. 4 illustrates only one side part between the corner parts of the gasket 4, but the thickness T increases from the end part in the vicinity of the corner part toward the center part also at other side parts.

In the terminal block 1, a depth D of the housing groove 34 is formed to be the same in a direction in which the housing groove 34 extends. That is, the depth D of the housing groove 34 does not vary in the direction in which the housing groove 34 extends. Due to this, as described above, since the thickness T of the gasket 4 varies in the extending direction, a projecting length of the pressing part 41 of the gasket 4 projecting from the housing groove 34 varies in the extending direction. For example, the projecting length increases from the end part toward the center part at a side part between the corner parts of the gasket 4. That is, as illustrated in FIG. 5 and FIG. 6, assuming that the projecting length of the pressing part 41 at the center part of the gasket 4 is L1 and the projecting length of the pressing part 41 at the end part of the gasket 4 is L2, the projecting length of the pressing part 41 is set to satisfy L1 > L2. FIG. 4 illustrates only one side part between the corner parts of the gasket 4, but the projecting length of the pressing part 41 increases from the end part in the vicinity of the corner part toward the center part also at other side parts.

In the gasket 4, a difference (T1 - T2) in the thickness between the thickness T1 at the center part distant from the fastening member 5 and the thickness T2 at the end part in the vicinity of the fastening member 5 is set in accordance with rigidity of the housing 3. The difference in the thickness is an absolute value of the difference. For example, in the gasket 4, the difference in the thickness between the thickness T1 at the center part distant from the fastening member 5 and the thickness T2 at the end part in the vicinity of the fastening member 5 is set to be smaller as the rigidity of the housing 3 is higher, and is set to be larger as the rigidity of the housing 3 is lower. That is, since deflection of the housing 3 is smaller as the rigidity of the housing 3 is higher, an amount of deflection of the main body part 31 at the center part in the assembly direction Z is reduced when the terminal block 1 is fastened to the object to be fixed 90. Accordingly, even if the difference in the thickness between the thickness T1 at the center part distant from the fastening member 5 and the thickness T2 at the end part in the vicinity of the fastening member 5 is small, the pressing force of the gasket 4 can be easily made uniform, and water blocking can be appropriately performed by the gasket 4. On the other hand, since deflection of the housing 3 is larger as the rigidity of the housing 3 is lower, an amount of deflection of the main body part 31 at the center part in the assembly direction Z is increased when the terminal block 1 is fastened to the object to be fixed 90. Accordingly, by increasing the difference in the thickness between the thickness T1 at the center part distant from the fastening member 5 and the thickness T2 at the end part in the vicinity of the fastening member 5, the pressing force of the gasket 4 can be easily made uniform, and water blocking can be appropriately performed by the gasket 4.

In the gasket 4, for example, a difference (L1 - L2) in the projecting length between the projecting length L1 of the pressing part 41 at the center part distant from the fastening member 5 and the projecting length L2 of the pressing part 41 at the end part in the vicinity of the fastening member 5 is set in accordance with the rigidity of the housing 3. The difference in the projecting length is an absolute value of the difference. For example, regarding the projecting length of the gasket 4 from the housing groove 34, the difference in the projecting length between the projecting length L1 at the center part distant from the fastening member 5 and the projecting length L2 of the pressing part 41 at the end part in the vicinity of the fastening member 5 is set to be smaller as the rigidity of the housing 3 is higher, and is set to be larger as the rigidity of the housing is lower. That is, since deflection of the housing 3 is smaller as the rigidity of the housing 3 is higher, an amount of deflection of the main body part 31 at the center part in the assembly direction Z is reduced when the terminal block 1 is fastened to the object to be fixed 90. Accordingly, even if the difference in the projecting length between the projecting length L1 at the center part distant from the fastening member 5 and the projecting length L2 of the pressing part 41 at the end part in the vicinity of the fastening member 5 is small, the pressing force of the gasket 4 can be easily made uniform, and water blocking can be appropriately performed by the gasket 4. On the other hand, since deflection of the housing 3 is larger as the rigidity of the housing 3 is lower, an amount of deflection of the main body part 31 at the center part in the assembly direction Z is increased when the terminal block 1 is fastened to the object to be fixed 90. Accordingly, by increasing the difference in the projecting length between the projecting length L1 at the center part distant from the fastening member 5 and the projecting length L2 of the pressing part 41 at the end part in the vicinity of the fastening member 5, the pressing force of the gasket 4 can be easily made uniform, and water blocking can be appropriately performed by the gasket 4.

Next, the following describes assembly of the terminal block 1 according to the present embodiment.

The terminal block 1 according to the present embodiment is assembled to the object to be fixed 90, for example, by arranging the terminal block 1 to face the object to be fixed 90 and fastening the terminal block 1 to the object to be fixed 90 with the fastening member 5.

In FIG. 2 and FIG. 3, the terminal block 1 is assembled by assembling the terminals 2 and the gasket 4 to the housing 3, and the terminal block 1 is arranged so that the back surface part 31B of the main body part 31 of the housing 3 faces the attachment surface 91 of the object to be fixed 90.

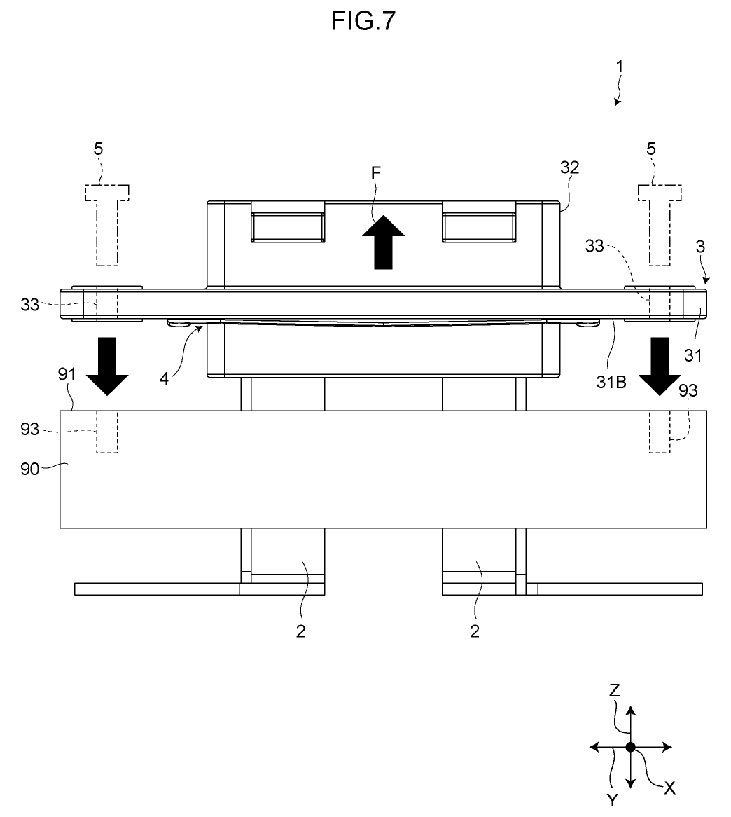

As illustrated in FIG. 7, the back surface part 31B of the main body part 31 is brought closer to the attachment surface 91 of the object to be fixed 90, and the pressing part 41 of the gasket 4 is caused to abut against the attachment surface 91. In this state, the fastening member 5 is inserted through the fastening hole 33 of the main body part 31, and fastening is performed by the fastening member 5. A distal end of the fastening member 5 is inserted into the fastening hole 93 of the object to be fixed 90, and the main body part 31 is pressed against the object to be fixed 90 by fastening. Due to this, the gasket 4 is pressed against the attachment surface 91 to perform water blocking between the object to be fixed 90 and the housing 3.

At this time, in the terminal block 1 according to the present embodiment, the projecting length L1 of the pressing part 41 of the gasket 4 at the center part distant from the fastening member 5 is longer than the projecting length L2 of the pressing part 41 of the gasket 4 at the end part in the vicinity of the fastening member 5, so that water blocking can be appropriately performed by the gasket 4.

That is, when the terminal block 1 is fastened to the object to be fixed 90 by the fastening member 5, the main body part 31 of the housing 3 is strongly pressed against the object to be fixed 90 at the position of the fastening member 5. Due to this, the gasket 4 is pressed against the object to be fixed 90, and the main body part 31 receives a reaction force from the object to be fixed 90 via the gasket 4. Due to this, the main body part 31 may be deformed, and a center portion of the main body part 31 may be deflected in a direction (upward direction in FIG. 7) opposite to the fastening direction (downward direction in FIG. 7). An amount of deflection of the main body part 31 corresponds to rigidity of the main body part 31 and the housing 3. Due to this, if the projecting length of the gasket 4 is the same along the extending direction, the pressing force on the object to be fixed 90 becomes low at the center portion of the gasket 4, and it becomes difficult to secure a sufficient water-blocking function.

On the other hand, in the terminal block 1 according to the present embodiment, the gasket 4 is formed to be thinner in the assembly direction Z as being closer to the fastening member 5, the projecting length of the pressing part 41 of the gasket 4 becomes shorter as being closer to the fastening member 5, the gasket 4 is formed to be thicker in the assembly direction Z as being farther from the fastening member 5, and the projecting length of the pressing part 41 of the gasket 4 becomes longer as being farther from the fastening member 5. Due to this, the terminal block 1 according to the present embodiment can increase the pressing force of the gasket 4 at a position distant from the fastening member 5, and can appropriately perform water blocking by the gasket 4. In addition, the terminal block 1 according to the present embodiment can suppress a pressing force of the gasket 4 and a reaction force from the object to be fixed 90 in the vicinity of the fastening member 5, can reduce strength and rigidity required for the housing 3, and can achieve size reduction and cost reduction of the housing 3.

As illustrated in FIG. 1, when the terminal block 1 is fastened to the object to be fixed 90 by the fastening member 5, assembly of the terminal block 1 to the object to be fixed 90 is completed.

As described above, in the terminal block 1 according to the present embodiment, the gasket 4 is formed to be thinner as being closer to the fastening member 5, so that the projecting length of the pressing part 41 of the gasket 4 is shorter as being closer to the fastening member 5. Due to this, the terminal block 1 according to the present embodiment can increase the pressing force of the gasket 4 at a position distant from the fastening member 5 while suppressing a reaction force against the pressing force of the gasket in the vicinity of the fastening member 5, and can appropriately perform water blocking by the gasket 4.

In the terminal block 1 according to the present embodiment, the housing groove 34 is formed to have the same depth along the pressing direction in the extending direction, so that the projecting length of the pressing part 41 of the gasket 4 can be made shorter as being closer to the fastening member 5 and can be made longer as being farther from the fastening member 5. Due to this, the terminal block 1 according to the present embodiment can increase the pressing force of the gasket 4 at a position distant from the fastening member 5 while suppressing a reaction force from the object to be fixed 90 in the vicinity of the fastening member 5, and can appropriately perform water blocking by the gasket 4.

The terminal block according to the present invention is not limited to the embodiment described above, and can be variously modified within the scope of the claims. The terminal block 1 according to the present embodiment may be configured by appropriately combining the constituent elements in the embodiment and modifications described above.

For example, although the terminal block 1 according to the embodiment described above is mounted on the vehicle, it may be used for an object other than the vehicle.

With the terminal block according to the present embodiment, water blocking can be appropriately performed by the gasket.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a housing that holds terminals;
a gasket that is assembled to the housing to perform water blocking between the housing and an object to be fixed; and
a fastening member that fastens the housing to the object to be fixed, wherein
the gasket is housed in a housing groove formed in the housing, presses a pressing part projecting from the housing groove against the object to be fixed to perform water blocking, and is formed to have a thickness in a pressing direction that becomes thinner as being closer to the fastening member.

2. The terminal block according to claim 1, wherein the housing groove is formed so that a depth along the pressing direction is the same in an extending direction.
